(19) United States
(12) Patent Application Publication
(10) Pub. No.: US 2015/0075008 A1
(43) Pub. Date: Mar. 19, 2015

(54) SELF-STANDING HYGIENIC SAFETY KITCHEN KNIFE

(71) Applicant: Sung-Jun Oh, Gyeonggi-do (KR)

(72) Inventor: Sung-Jun Oh, Gyeonggi-do (KR)

(21) Appl. No.: 14/386,821

(22) PCT Filed: Mar. 20, 2013
(86) PCT No.: PCT/KR2013/002273

§ 371 Date: Sep. 22, 2014

(30) Foreign Application Priority Data
Mar. 22, 2012 (JP) 10-2012-0029104

(51) Int. Cl. B26B 3/00

(52) U.S. Cl. CPC B26B 3/00
USPC 30/165

(57) ABSTRACT

The present invention relates to a kitchen knife for trimming food ingredients in a kitchen or galley, and more particularly, relates to a self-standing hygienic safety kitchen knife which is adapted to be able to maintain a hygienic state when the knife is placed on a chopping board or sink, by ensuring that the knife blade portion is separated from the deck such that extraneous material does not stick to the knife blade for trimming the food ingredients and such that water on the knife blade falls towards a ground surface. The self standing hygiene kitchen knife of the present invention is a kitchen knife having a handle, wherein the handle is formed so as to have a circular cross section, and the centre of gravity of the handle is formed in the lower part of the handle in the knife-blade direction, and where the knife blade is concerned, the knife blade is constituted spaced a predetermined distance inwards from the outer surface of the handle.

### TECHNICAL FIELD

The present invention relates to a kitchen knife for trimming food ingredients in a kitchen or a galley, and more particularly, relates to a self-standing hygienic safety kitchen knife which is adapted to be able to maintain a hygienic state when the knife is placed on a chopping board or sink, by ensuring that the knife blade portion is separated from the deck such that extraneous material does not stick to the knife blade for trimming the food ingredients and such that water on the knife blade falls towards a ground surface.

### BACKGROUND ART

A kitchen knife used for trimming food ingredients in a kitchen or a galley is generally constituted in such a way that a knife blade section is larger than a handle.

The above-mentioned kitchen knife used for trimming food ingredients in a kitchen always has moisture on its blade because such a kitchen knife cuts a variety of food ingredients which contain a lot of water. When the kitchen knife is placed on a chopping board or a sink after using the kitchen knife, extraneous material such as food fragments, dirt, etc. may stick to the knife blade, thus contaminating the kitchen knife, which results in hygienic problems.

In addition, when the related kitchen knife is placed on a chopping board or somewhere else, the knife blade is always placed with its blade facing in a lateral direction. In this state, a cook may get wounded by a laterally facing blade of the knife while the cook moves his hands here and there on the sink. If such a knife is placed on the ground with its blade facing in a lateral direction, the cook's feet may get wounded by a laterally facing blade of the knife, thus causing negligent accident.

### DISCLOSURE OF INVENTION

### Technical Problem

Accordingly, the present invention is made in an effort to improve the above-described problems. It is an object of the present invention to provide a self-standing hygienic safety kitchen knife which is adapted to be able to maintain a hygienic state when the knife is placed on a chopping board or sink, by ensuring that the knife blade portion is separated from the deck such that extraneous material such as food fragments, dirt, etc. does not stick to the knife blade when trimming the food ingredients.

It is another object of the present invention to provide a self-standing hygienic safety kitchen which makes it possible to prevent any negligent accidents, for example, cook's hands or feet get wounded, in such a way that a blade portion of a kitchen knife always faces the ground when the kitchen knife is placed on a sink deck or a chopping board and which also makes it possible to prevent any hygienic problems in such a way that water stuck on the knife blade falls toward the ground, so the kitchen knife may always maintain a dry state.

### Solution to Problem

To achieve the above objects, there is provided a self-standing hygienic safety kitchen knife, comprising a handle which has a circular cross section, wherein the center of gravity of the handle is formed at a lower side of the handle in a direction of a knife blade, and the knife blade is formed spaced apart in an inward direction by a predetermine distance “Dₕ” from an outer surface of the handle.

To achieve the above objects, there is provided a self-standing hygienic safety kitchen knife, comprising a handle which has a circular cross section, wherein a groove portion is formed at the handle of the opposite side of the knife blade, and the knife blade is formed spaced apart in an inward direction by a predetermine distance “Dₕ” from an outer surface of the handle.

Here, the handle is made of a metallic material.

### Advantageous Effects

In the self-standing hygienic safety kitchen knife, it is advantageous in the way that it is possible to always maintain a hygienic state when the knife is placed on a chopping board or sink, by ensuring that the knife blade portion is separated from the deck such that extraneous material such as food fragments, dirt, etc. does not stick to the knife blade.

In addition, the kitchen knife according to the present invention is advantageous in the way that the blade portion of the kitchen knife always faces the ground when the knife is placed on a sink deck or a chopping board because the center of gravity is formed at the lower side of the knife, so the knife may always maintain a dry state because the water stuck on the knife falls toward the ground. Since the blade portion of the knife always faces the ground, it is possible to prevent any negligent accidents, for example, the cook's hands or feet get wounded by the blade portion of the knife.

### BRIEF DESCRIPTION OF DRAWINGS

FIG. 1 is a side view illustrating a self-standing hygienic safety kitchen knife according to the present invention.

FIG. 2 is a plane view illustrating a self-standing hygienic safety kitchen knife according to the present invention.

FIG. 3 is a view illustrating a state that a blade portion of a kitchen knife stands by itself according to the present invention.

### LEGEND OF MAJOR COMPONENTS OF THE DRAWING

100: kitchen knife
101: handle
102: groove portion
103: knife blade
104: knife spine
Dh: a distance that a knife blade is spaced apart in an inward direction from an outer surface of a handle

### BEST MODES FOR CARRYING OUT THE INVENTION

The self-standing hygienic safety kitchen knife according to the present is invention will be described with reference to the accompanying drawings.

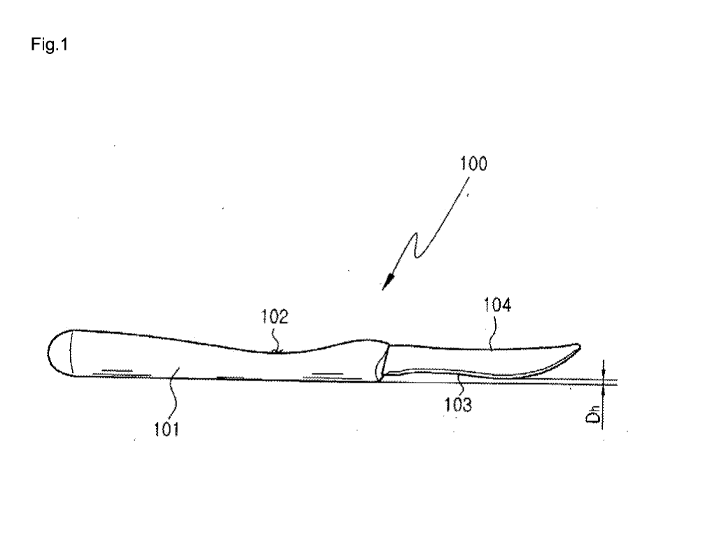

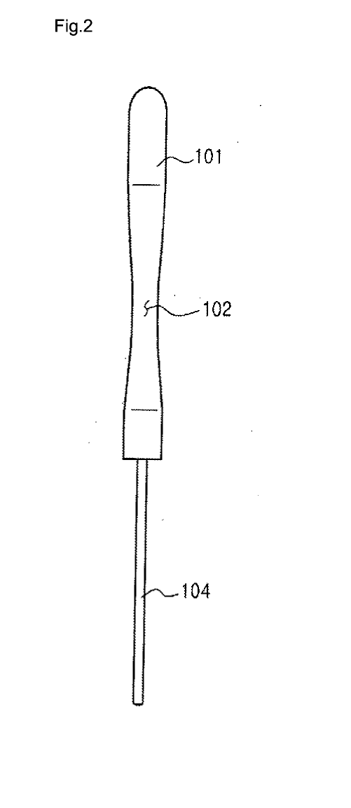

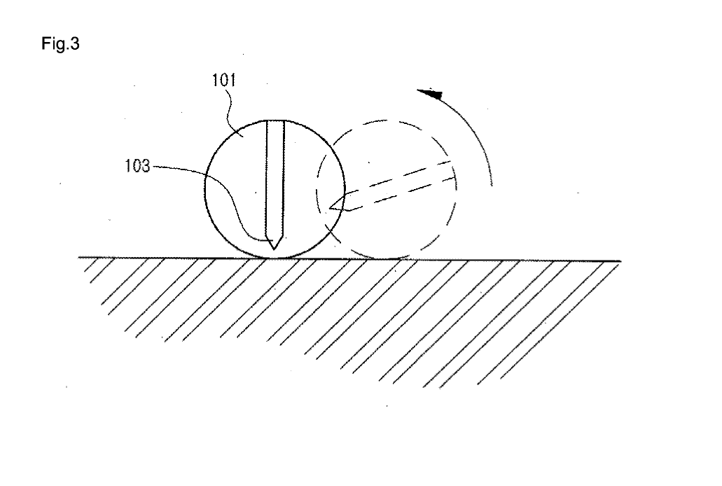

FIG. 1 is a side view illustrating a self-standing hygienic safety kitchen knife according to the present invention. FIG. 2 is a plane view illustrating a self-standing hygienic safety kitchen knife according to the present invention. FIG. 3 is a view illustrating a state that a blade portion of a kitchen knife stands by itself according to the present invention.

Referring to FIG. 1, the self-standing hygienic safety kitchen knife 100 according to the present invention comprises a knife and a handle 101.

As illustrated in FIG. 1, the section of the knife blade 103 of the kitchen knife 100 is defined as a lower side, the section of the knife spine 104 is defined as an upper side.

The self-standing hygienic safety kitchen knife 100 according to the present invention is characterized in that when the self-standing hygienic safety kitchen knife 100 is placed on a flat place such as a chopping board or a sink deck, the knife blade 103 of the kitchen knife 100 rotates to face the ground, so the kitchen knife 100 stands by itself. In order for the knife blade 103 to rotate by itself so that the knife blade 103 can face the ground, as illustrated in FIGS. 1 and 2, the cross section of the handle 101 of the kitchen knife 100 is circular, and the center of gravity of the handle 101 is formed at the lower side.

As illustrated in FIGS. 1 and 2, the cross section of the handle 101 of the kitchen knife 100 is circular, and the handle 101 is configured in such a way that the center of gravity of the handle 101 is at the lower side, so the center of gravity tends to become close to the ground surface. Based on the above-described characteristic, when the kitchen knife 100 is placed on a predetermined flat surface, the center of gravity of the handle 101 moves to a portion close to the ground surface, and the handle 101 with the circular cross section rolls, so the center of the gravity of the handle 101 moves to a portion close to the ground surface.

As illustrated in FIG. 1, the knife blade 103 of the kitchen knife 100 is configured in such a way that the knife blade 103 of the kitchen knife 100 faces the direction of the center of gravity of the handle 101, more specifically, the direction of the lower side of the handle 101, and as illustrated in FIG. 1, the knife blade 103 is positioned spaced apart in an inward direction by a predetermined distance “Dₕ” from the outer surface of the lower side of the handle 101.

Since the knife blade 103 of the kitchen knife 100 is spaced apart by a predetermined distance “Dₕ” from the outer surface of the lower side of the handle 101, when the kitchen knife 100 is placed on a flat surface, the kitchen knife 100 rolls so that the center of gravity of the handle 101 is positioned at the lowest portion, and the knife blade 103 can always face the ground surface, and is the knife blade 103 is spaced apart in ward by a predetermined distance “Dₕ” from the outer surface of the handle 101, whereby the knife blade 103 does not interfere with other portions when the handle 101 rolls.

In addition, since the knife blade 103 is spaced apart by a predetermined distance “Dₕ” from the ground surface, the extraneous material such as food fragments, dirt, etc. on the deck does not stick to the knife blade 103. As illustrated in FIGS. 1 and 2, since the blade portion of the kitchen knife 100 always faces the ground surface in a vertical direction, water stuck on the knife blade 103 fast falls toward the ground surface, so it is possible to maintain the knife hygienic all the time.

At this time, the knife can freely rotate without any interference with other portions when the handle 101 of the kitchen knife 100 rotates only when the knife blade 103 of the knife as well as the end of the knife spine 104 are positioned at an inner side as compared with the outer surface of the handle 101.

In the self-standing hygienic safety kitchen knife according to the present invention, since the center of gravity of the handle 101 is formed at the lower side, when the kitchen knife 100 is placed on a predetermined flat place such as a chopping board or a sink deck, the kitchen knife 100 rotates and becomes the states illustrated in FIGS. 1 and 2. There are a variety of ways for forming the is center of gravity of the handle 101.

As illustrated in FIG. 1, as an exemplary embodiment of the present invention, a concave groove portion 102 may be formed on the top of the handle 101 having a circular cross section, so the center of gravity of the handle 101 can be formed at a lower side. As illustrated in FIG. 3, even when the kitchen knife 100 is randomly placed on a predetermined flat place, the handle 101 rotates in order for the center of gravity of the handle 101 to face the ground surface, so the knife blade 103 of the kitchen knife always faces the ground surface.

At this time, it is preferred that the handle 101 of the kitchen knife 100 is made from a little heavy and rust-free metallic material. Since the handle 101 is made from a little heavy material in order for the center of gravity to form at a lower side, the kitchen knife 100 can fast stand by itself.

As not illustrated in the drawings, it is possible to form the center of gravity at a lower side of the handle 101 by inserting a predetermined weight (not shown) at the lower side of the handle 101.

In the above-described exemplary embodiment of the present invention, since the center of gravity is formed at the handle 101, even when the kitchen knife falls onto a cooking surface or a dining table, the heavier handle 101 first falls onto the ground surface faster than the knife blade, not the knife blade, so is any negligent accidents may be prevented.

Even when the self-standing hygienic safety kitchen knife according to the present invention is placed on a sink deck or a chopping board, since the blade portion of the kitchen knife does not contact with the surface of the sink deck or the chopping board, the knife blade does not contact with any extraneous material such as food fragments, dirt, etc., it is possible to use the kitchen knife in a hygienic state all the time.

In the kitchen knife according to the present invention, since the center of gravity is formed at a lower side, when the kitchen knife is placed on a sink deck or a chopping board, the blade portion of the kitchen knife always faces the ground surface, so water stuck on the kitchen knife falls onto the ground surface, whereby it is possible to use the kitchen knife in a dry state all the time. Since the knife blade always faces the ground surface, it is possible to prevent any negligent accidents, for example, cook's hands or feet get wounded.

The above-described exemplary embodiments of the present invention are provided for illustrative purposes and should understood in such a way that the above-described examples are not limited by any of the details of the foregoing description, unless otherwise specified, but rather should be construed broadly within its spirit and scope as defined in the appended claims, and therefore all changes and modifications that fall within the meets and is bounds of the claims, or equivalences of such meets and bounds are therefore intended to be embraced by the appended claims.

What is claimed is:

1. A self-standing hygienic safety kitchen knife 100, comprising:
a handle 101 which has a circular cross section, wherein the center of gravity of the handle 101 is formed at a lower side of the handle 101 in a direction of a knife blade 103, and the knife blade 103 is formed spaced apart in an inward direction by a predetermine distance “Dₕ” from an outer surface of the handle 101.

2. A self-standing hygienic safety kitchen knife 100, comprising:
a handle 101 which has a circular cross section, wherein a groove portion 102 is formed at the handle 101 of the opposite side of the knife blade 103, and the knife blade 103 is formed spaced apart in an inward direction by a predetermine distance “Dₕ” from an outer surface of the handle 101.

3. The knife of claim 2, wherein the handle 101 is made of a metallic material.
